(19) United States
(12) Patent Application Publication
(10) Pub. No.: US 2011/0111792 A1
(43) Pub. Date: May 12, 2011

(54) System and method for effectively implementing a composite antenna for a wireless transceiver device

(75) Inventor: Bernard Griffiths, Ben Lomond, CA (US)

(73) Assignee: Sony Corporation

(21) Appl. No.: 12/590,680

(22) Filed: Nov. 12, 2009

(51) Int. Cl. H04W 88/06

(52) U.S. Cl. 455/553.1

(57) ABSTRACT

A system and method for implementing a wireless transceiver device includes a composite antenna that is configured to include both a low-frequency antenna and a high-frequency antenna that are connected in a series configuration. The composite antenna is supported by an integrated circuit that includes a low-frequency circuit, a high-frequency circuit, and an impedance matching circuit. The low-frequency circuit supports low-frequency communications over the low-frequency antenna without high-frequency suppression from the high-frequency circuit or high-frequency antenna. The high-frequency circuit supports simultaneous high-frequency communications over the high-frequency antenna without low-frequency suppression from the low-frequency circuit or low-frequency antenna.

### BACKGROUND SECTION

1. Field of the Invention

This invention relates generally to techniques for transferring electronic information, and relates more particularly to a system and method for effectively implementing a composite antenna for a wireless transceiver device.

2. Description of the Background Art

Implementing effective methods for transferring electronic information is a significant consideration for designers and manufacturers of contemporary electronic systems. However, effectively implementing data transfer systems may create substantial challenges for system designers. For example, enhanced demands for increased system functionality and performance may require more system processing power and require additional hardware resources. An increase in processing or hardware requirements may also result in a corresponding detrimental economic impact due to increased production costs and operational inefficiencies.

Furthermore, enhanced system capability to perform various advanced transfer operations may provide additional benefits to a system user, but may also place increased demands on the control and management of various system components. For example, an enhanced electronic system that effectively transfers digital image data may benefit from an effective implementation because of the large amount and complexity of the digital data involved.

Due to growing demands on system resources and substantially increasing data magnitudes, it is apparent that developing new techniques for implementing and utilizing data transfer systems is a matter of concern for related electronic technologies. Therefore, for all the foregoing reasons, developing effective systems for transferring electronic information remains a significant consideration for designers, manufacturers, and users of contemporary electronic systems.

### SUMMARY

In accordance with the present invention, a system and method are disclosed for effectively implementing a composite antenna for a wireless transceiver. In accordance with one embodiment of the present invention, the composite antenna is configured to include both a low-frequency antenna and a high-frequency antenna that are connected in a series configuration. The composite antenna is supported by an integrated circuit that includes a low-frequency circuit, a high-frequency circuit, and an impedance matching circuit.

The low-frequency circuit supports low-frequency communications over the low-frequency antenna without high-frequency suppression from the high-frequency circuit or high-frequency antenna. The high-frequency circuit supports simultaneous high-frequency communications over the high-frequency antenna without low-frequency suppression from the low-frequency circuit or low-frequency antenna.

In one embodiment of the present invention, a data transmission system includes a host device and an electronic device that includes the foregoing wireless transceiver. The host device and the electronic device simultaneously communicate with each other via a low-frequency (LF) communication link and a high-frequency (HF) communication link. In certain embodiments, the LF communication link may typically operate at a megahertz frequency, while the high-frequency (HF) communication link may operate at a gigahertz frequency that is at least approximately 100 times greater than the megahertz frequency.

In one embodiment, the electronic device may be implemented as any appropriate type of electronic apparatus or entity. For example, the electronic device may be implemented as an enhanced smart card (such as a Felica device manufactured by Sony Corporation). In certain other embodiments, the electronic device may be implemented as any type of stationary or portable electronic device, such as a personal computer, a consumer-electronics device, a cellular telephone, an audio-visual entertainment device, or a personal digital assistant (PDA).

In one embodiment, the composite antenna is coupled to an integrated circuit of the transceiver via two or fewer connection terminals. Combining the low-frequency antenna and the high-frequency antenna in series advantageously allows the two systems to use the same composite antenna to operate concurrently. The impedance of the high-frequency resonant circuit is effectively zero at the opposing low-frequency. Similarly, the impedance of the low-frequency resonant circuit is effectively zero at the opposing high-frequency.

The high-frequency components thus operate without any suppression from the low-frequency components of the transceiver. Likewise, the low-frequency components simultaneously operate without any suppression from the high-frequency components of the transceiver. For at least the foregoing reasons, the present invention therefore provides an improved system and method for effectively implementing a composite antenna for a wireless transceiver device.

### BRIEF DESCRIPTION OF THE DRAWINGS

FIG. 1 is a block diagram of a data transmission system, in accordance with one embodiment of the present invention;

FIG. 2 is a block diagram for one embodiment of the device of FIG. 1, in accordance with the present invention;

FIGS. 3A and 3B are exemplary diagrams of the transceiver from FIG. 2, in accordance with certain embodiments of the present invention;

FIG. 4 is a block diagram for the integrated circuit of FIG. 3, in accordance with one embodiment of the present invention;

FIG. 5 is an impedance diagram for the transceiver of FIG. 3, in accordance with one embodiment of the present invention;

FIGS. 6A and 6B are equivalent circuits for low-frequency operation of the transceiver of FIG. 3, in accordance with one embodiment of the present invention;

FIGS. 7A and 7B are equivalent circuits for high-frequency operation of the transceiver of FIG. 3, in accordance with one embodiment of the present invention; and

FIGS. 8A-8C are frequency response graphs for the transceiver of FIG. 3, in accordance with one embodiment of the present invention.

### DETAILED DESCRIPTION

The present invention relates to an improvement in data transmission systems. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention is described herein as a system and method for implementing a wireless transceiver device, and includes a composite antenna that is configured to include both a low-frequency antenna and a high-frequency antenna that are connected in a series configuration. The composite antenna is supported by an integrated circuit that includes a low-frequency circuit, a high-frequency circuit, and an impedance matching circuit. The low-frequency circuit supports low-frequency communications over the low-frequency antenna without high-frequency suppression from the high-frequency circuit or high-frequency antenna. The high-frequency circuit supports simultaneous high-frequency communications over the high-frequency antenna without low-frequency suppression from the low-frequency circuit or low-frequency antenna.

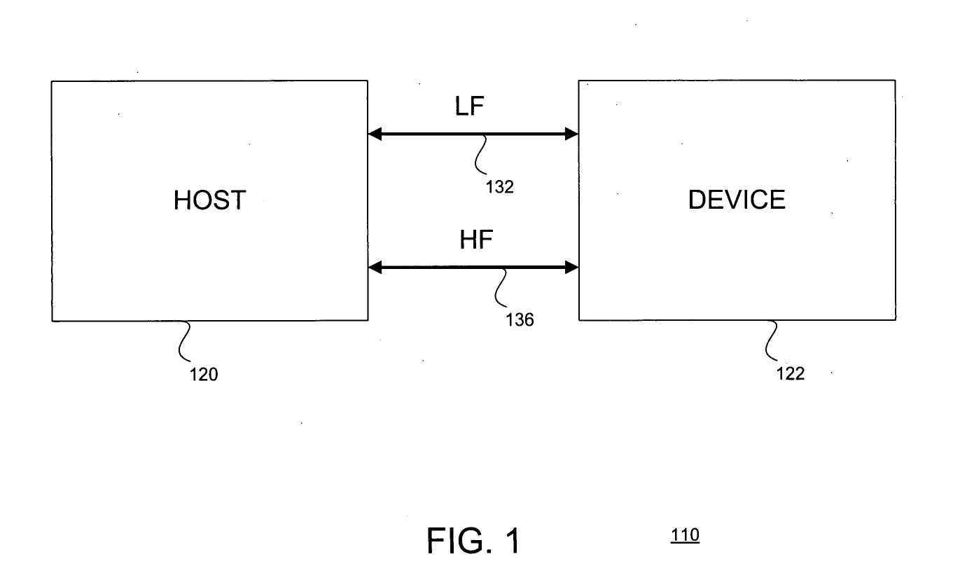

Referring now to FIG. 1, a block diagram of a data transmission system 110 is shown, in accordance with one embodiment of the present invention. In the FIG. 1 embodiment, data transmission system 110 includes, but is not limited to, a host 120 and a device 122. In alternate embodiments, data transmission system 110 may be implemented using components and configurations in addition to, or instead of, certain of those components and configurations discussed in conjunction with the FIG. 1 embodiment. For example, any number of additional hosts 120 and/or devices 122 are equally contemplated for operating in a same or similar manner.

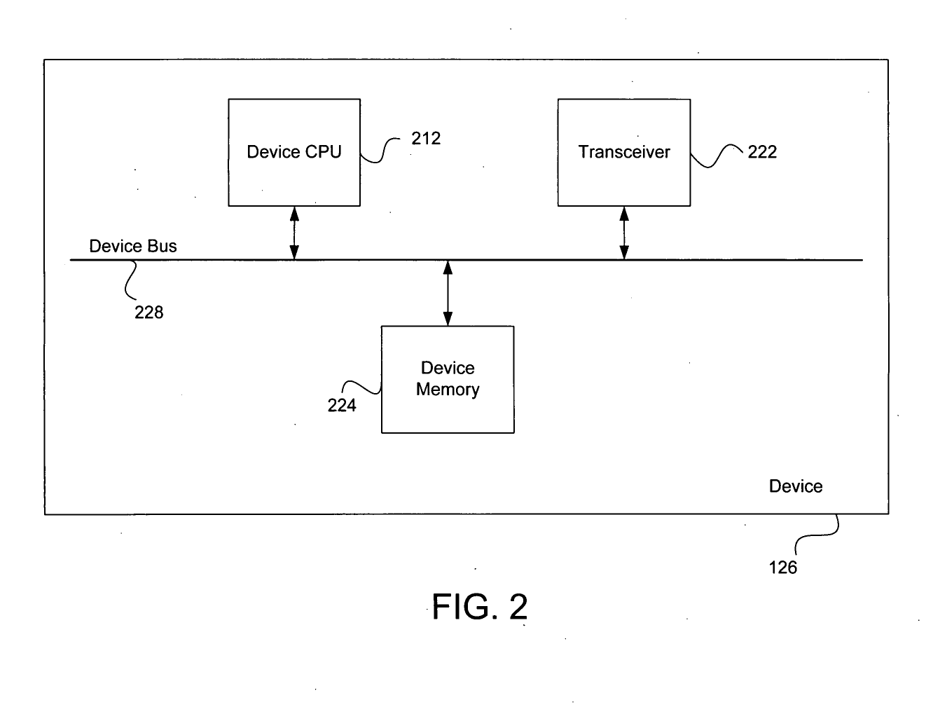

In the FIG. 1 embodiment of data transmission system 110, host 120 and device 122 may concurrently communicate with each other via both a low-frequency (LF) communication link 132 and a high-frequency (HF) communication link 136. In certain embodiments, LF communication link 132 may typically operate at a megahertz frequency, while high-frequency (HF) communication link 136 may operate at a gigahertz frequency that is at least approximately 100 times higher than the megahertz frequency. In one embodiment, LF communication link 132 operates at approximately 13 MHz, while the high-frequency (HF) communication link 136 operates at approximately 4 GHz. Further details regarding the implementation and utilization of device 122 are further discussed below in conjunction with FIGS. 2-8.

Referring now to FIG. 2, a block diagram for one embodiment of the FIG. 1 device 126 is shown, in accordance with the present invention. In the FIG. 2 embodiment, device 126 may include, but is not limited to, a device central processing unit (CPU) 212, a transceiver 222, and a device memory 224. In alternate embodiments, device 126 may be implemented using components and configurations in addition to, or instead of, certain of those components and configurations discussed in conjunction with the FIG. 2 embodiment.

In various embodiments, device 126 may be implemented as any appropriate type of electronic apparatus or entity. For example, device 126 may be implemented as an enhanced smart card (such as a Felica device manufactured by Sony Corporation), or as an enhanced radio-frequency identification device (RFID). In certain other embodiments, device 126 may be implemented as any type of stationary or portable electronic device, such as a personal computer, a consumer-electronics device, a cellular telephone, an audio-visual entertainment device, or a personal digital assistant (PDA).

In the FIG. 2 embodiment, device CPU 212 may be implemented to include any appropriate and compatible microprocessor device that preferably executes software instructions to thereby control and manage the operation of device 126. In the FIG. 2 embodiment, transceiver 222 may include any effective means of bi-directionally exchanging transmissions with an external entity such as host 120 (FIG. 1). In the FIG. 2 embodiment, device memory 224 may be implemented to include any combination of desired storage devices, including, but not limited to, read-only memory (ROM), random-access memory (RAM), and various types of non-volatile memory.

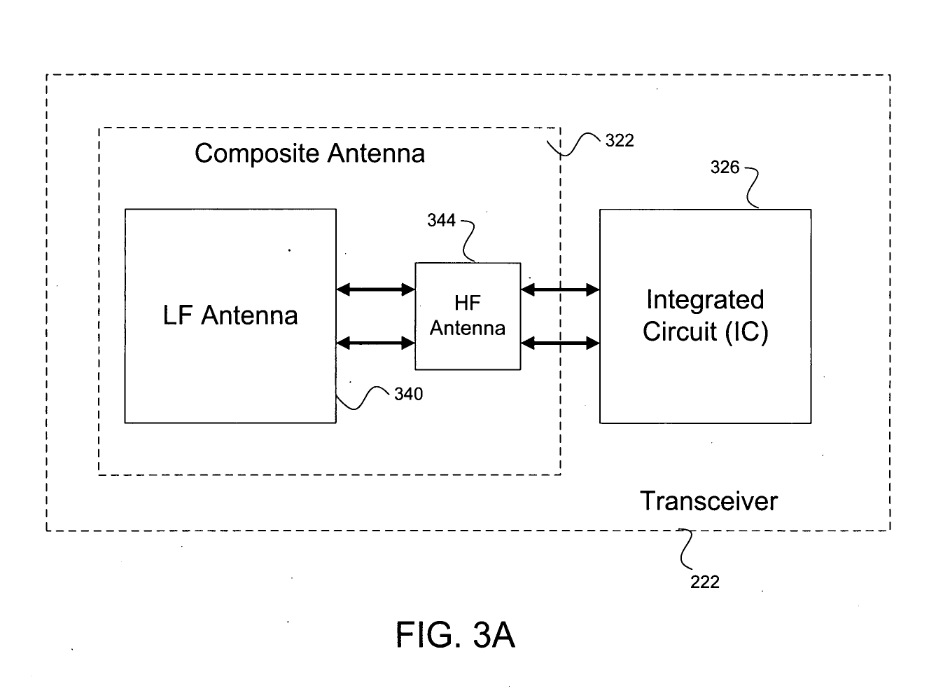

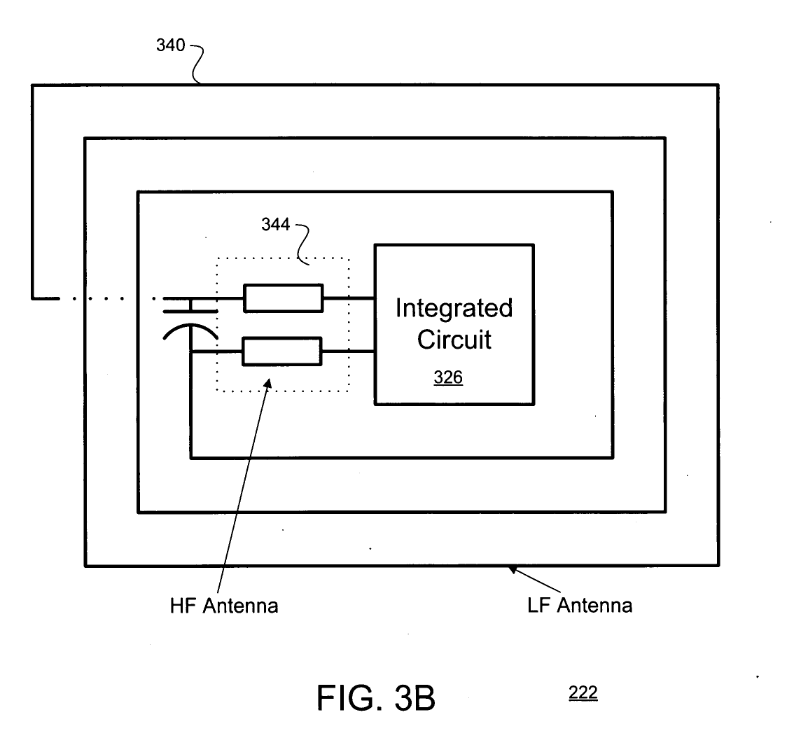

In the FIG. 2 embodiment, device memory 224 may include one or more device applications that are preferably executed by device CPU 512 to perform various functions and operations for device 126. The particular nature and functionality of the device application(s) typically varies depending upon factors such as the specific type and particular functionality of the corresponding device 126. Additional details for the implementation and utilization of transceiver 222 are further discussed below in conjunction with FIGS. 3-8.

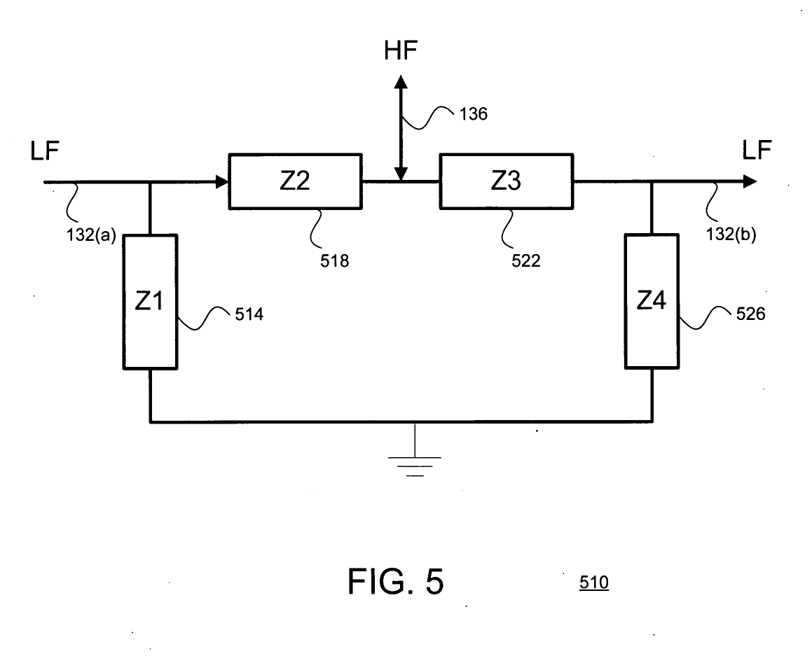

Referring now to FIGS. 3A and 3B, exemplary diagrams of the FIG. 2 transceiver 222 are shown, in accordance with certain embodiments of the present invention. The FIG. 3 diagrams are presented for purposes of illustration, and in alternate embodiments, transceivers 222 may be implemented with components, functionalities, and characteristics in addition to, or instead of, certain of those components, functionalities, and characteristics discussed in conjunction with the FIG. 3 embodiment. For example, FIG. 3B shows a specific configuration for composite antenna 322. However, other effective antenna configurations may be similarly utilized. In addition, FIG. 3 shows transceiver 222 with a differential implementation, however single-ended embodiments (such as the FIGS. 5-7 embodiments) are equally possible.

In the FIG. 3A embodiment, transceiver 222 includes a composite antenna 322 that is coupled to an integrated circuit 326 via two connection terminals. In the FIG. 3A embodiment, composite antenna 322 includes, but is not limited to, a high-frequency (HF) antenna 344 and a low-frequency (LF) antenna 340 that are connected in a series configuration. FIG. 3B shows a slightly different configuration for transceiver 222 in which a first end of a first portion of HF antenna 344 is connected to a first terminal of integrated circuit 326. A second end of the first portion of HF antenna 344 is connected in series with a first end of LF antenna 340.

In the FIG. 3B embodiment, LF antenna 340 is arranged in a roughly concentric rectangular configuration that decreases in size at each rectangular iteration. In alternate embodiments, LF antenna 340 may be any other effective shape or configuration including, but not limited to, circular, oval, square shapes. A second end of LF antenna 340 is connected to a second end of a second portion of HF antenna 344, and the first end of the second portion of HF antenna 344 is connected to a second terminal of integrated circuit 326. In the FIG. 3B embodiment, a capacitor is connected across the first and second ends of LF antenna 340 where these ends connect to HF antenna 344. In the FIG. 3B embodiment, HF antenna 344 and LF antenna 340 are thus connected to integrated circuit 326 in a series configuration to form composite antenna 322 (FIG. 3A).

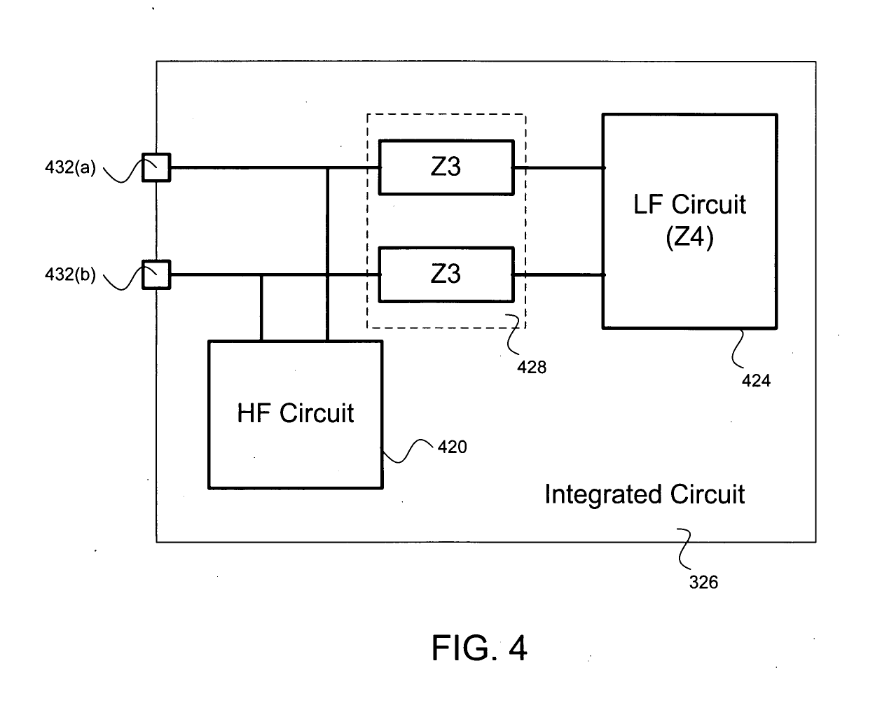

The FIG. 3 embodiments disclose transceiver 222 as a differential circuit that utilizes two terminals to couple to the composite antenna 322. In alternate embodiments, transceiver 222 may be implemented with a single-ended non-differential configuration that connects integrated circuit 326 to composite antenna 322 through a single terminal plus a ground connection. Additional details regarding the implementation and operation of transceiver 222 are further discussed below in conjunction with FIGS. 4-8.

Referring now to FIG. 4, a block diagram for the FIG. 3 integrated circuit 326 is shown, in accordance with one embodiment of the present invention. The FIG. 4 embodiment is presented for purposes of illustration, and in alternate embodiments, integrated circuit 326 may be implemented with components, functionalities, and characteristics in addition to, or instead of, certain of those components, functionalities, and characteristics discussed in conjunction with the FIG. 4 embodiment.

In the FIG. 4 embodiment, integrated circuit 326 is coupled to composite antenna 322 through two terminals 432(a) and 432(b) as also shown in FIGS. 3A and 3B. In the FIG. 4 embodiment, integrated circuit 326 includes, but is not limited to, a high-frequency (HF) circuit 420, a low-frequency (LF) circuit 424, and an impedance matching circuit 428. In the FIG. 4 embodiment, HF circuit 420 is directly coupled to composite antenna 322 through terminals 432(a) and 432(b) to support HF antenna 344 (see FIG. 3).

In the FIG. 4 embodiment, LF circuit 424 has an impedance of Z4, and is coupled to composite antenna 322 through impedance matching circuit 428 and terminals 432(a) and 432(b) to support LF antenna 340 (see FIG. 3). Impedance matching circuit has an impedance of Z3, and has a first impedance matching element connected to terminal 432(a), and a second impedance matching element connected to terminal 432(b). Impedance matching circuit 428 operates to match impedances and provide isolation between HF circuit 420 and LF circuit 424. Additional details regarding the implementation and operation of integrated circuit 326 are further discussed below in conjunction with FIGS. 5-8.

Referring now to FIG. 5, an impedance diagram 510 for the FIG. 3 transceiver 222 is shown, in accordance with one embodiment of the present invention. The FIG. 5 embodiment is presented for purposes of illustration, and in alternate embodiments, transceiver 222 may be implemented with impedances, functionalities, and characteristics in addition to, or instead of, certain of those impedances, functionalities, and characteristics discussed in conjunction with the FIG. 5 embodiment.

In the FIG. 5 embodiment, equivalent impedances of various elements of transceiver 222 are shown. For example, impedance Z1 514 corresponds to LF antenna 340 (FIG. 3), impedance Z2 518 corresponds to HF antenna 344 (FIG. 3), impedance Z3 corresponds to impedance matching circuit 428 (FIG. 4), and impedance Z4 corresponds to LF circuit 424 (FIG. 4). In the FIG. 5 embodiment, a high-frequency (HF) transmit/receive signal 136 is shown. In the FIG. 5 embodiment, a low-frequency (LF) receive signal 132(a) is shown, and a low-frequency (LF) transmit signal 132(b) is also shown.

The LF antenna 340 may consist of an antenna approximately the size of a credit card that operates in the MHz region. The LF antenna 340 may typically be utilized for small data transfers (such as short commercial financial transactions). Adding a HF antenna 344 that operates in the GHz region supports additional transfers of larger amounts of data (such as image data). Combining the two antennas in series effectively allows the two systems to use the same composite antenna 322 (FIG. 3). Separating the LF and HF systems (as shown in FIGS. 3 and 4) allows both LF and HF systems to operate concurrently without cross-interference. The impedance of each resonant circuit is effectively zero at the opposing frequency. Thus the GHz system is allowed to operate without any suppression from the MHz circuit. Similarly, the MHz system is allowed to operate without any suppression from the GHz circuit.

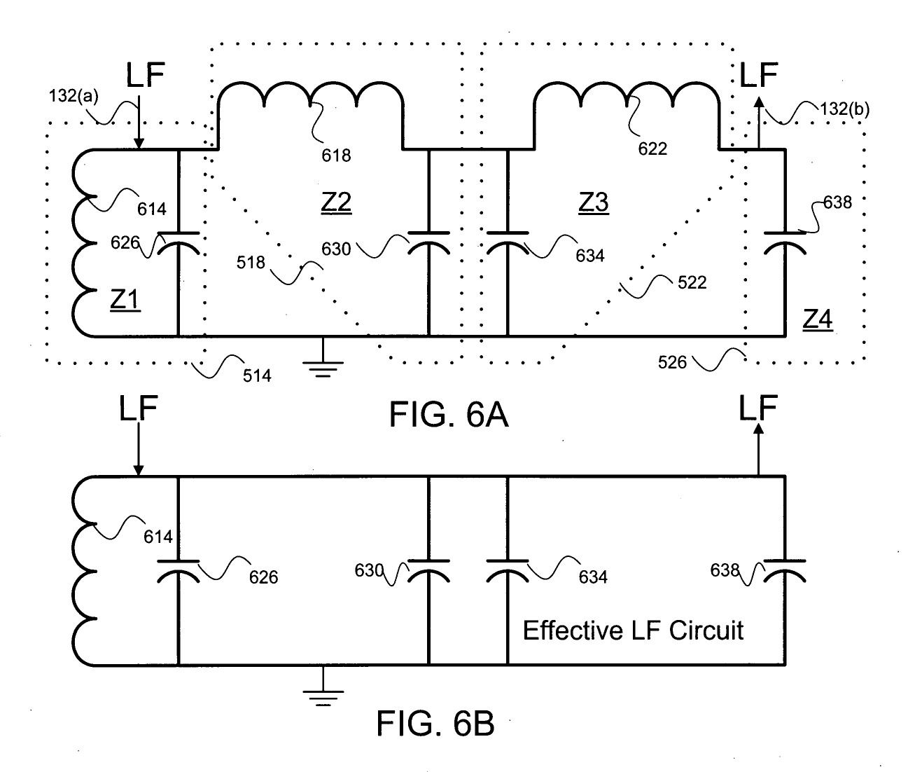

If you consider the impedances in the FIG. 5 embodiment, the HF system sees (Z2+Z1) in parallel with (Z3+Z4), but at the GHz frequency, the impedances of Z1 and Z4 approach zero. The HF system therefore only sees Z2 in parallel with Z3. The LF system sees Z4 in parallel with (Z3+Z2+Z1), but at the MHz frequency the impedances of Z2 and Z3 approach zero. The LF system therefore only sees Z4 in parallel with Z1. Additional details regarding the implementation and operation of transceiver 222 are further discussed below in conjunction with FIGS. 6-8.

Referring now to FIGS. 6A and 6B, equivalent circuits to illustrate low-frequency operation of the FIG. 3 transceiver 222 are shown, in accordance with certain embodiments of the present invention. The FIG. 6 diagrams are presented for purposes of illustration, and in alternate embodiments, transceivers 228 may be implemented with components, circuits, functionalities, and characteristics in addition to, or instead of, certain of those components, circuits, functionalities, and characteristics discussed in conjunction with the FIG. 6 embodiment.

The FIG. 6A embodiment is a simplified circuit for transceiver 222. In the FIG. 6A embodiment, impedance Z1 514, impedance Z2 618, impedance Z3 522, and impedance Z4 526 are analogous to the identically named and numbered impedances from FIGS. 4 and 5. Impedance Z1 514 includes, but is not limited to an inductance 614 and a capacitance 626. Impedance Z2 518 includes, but is not limited to, an inductance 618 and a capacitance 630. Impedance Z3 522 includes, but is not limited to, an inductance 622 and a capacitance 634. Impedance Z4 526 includes, but is not limited to, a capacitance 638. In the FIGS. 6A and 6B embodiments, a low-frequency (LF) receive signal 132(a) is shown, and a low-frequency (LF) transmit signal 132(b) is also shown.

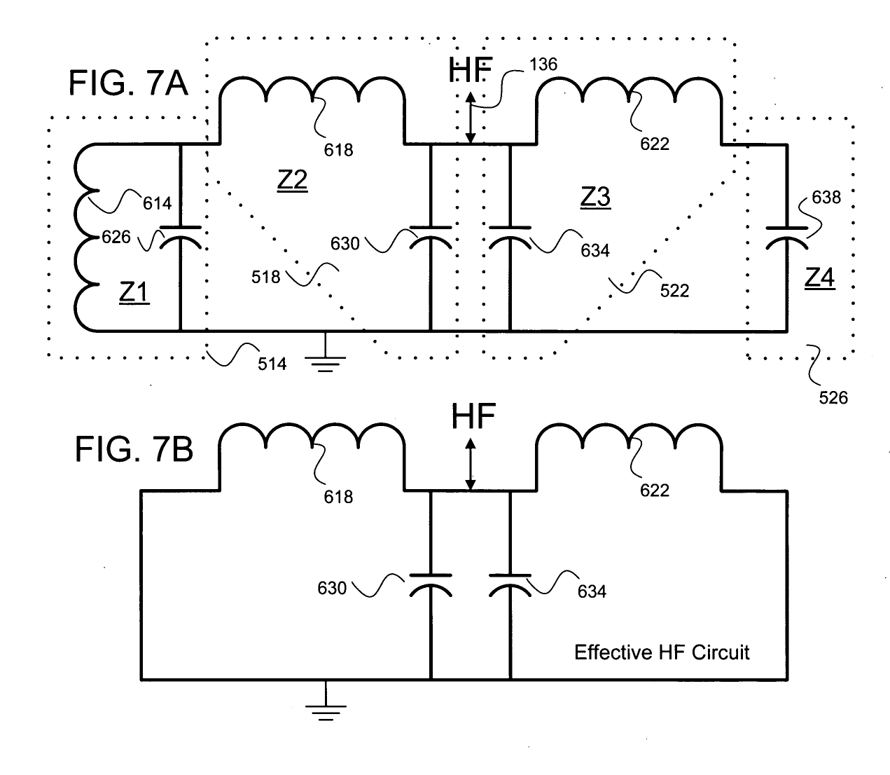

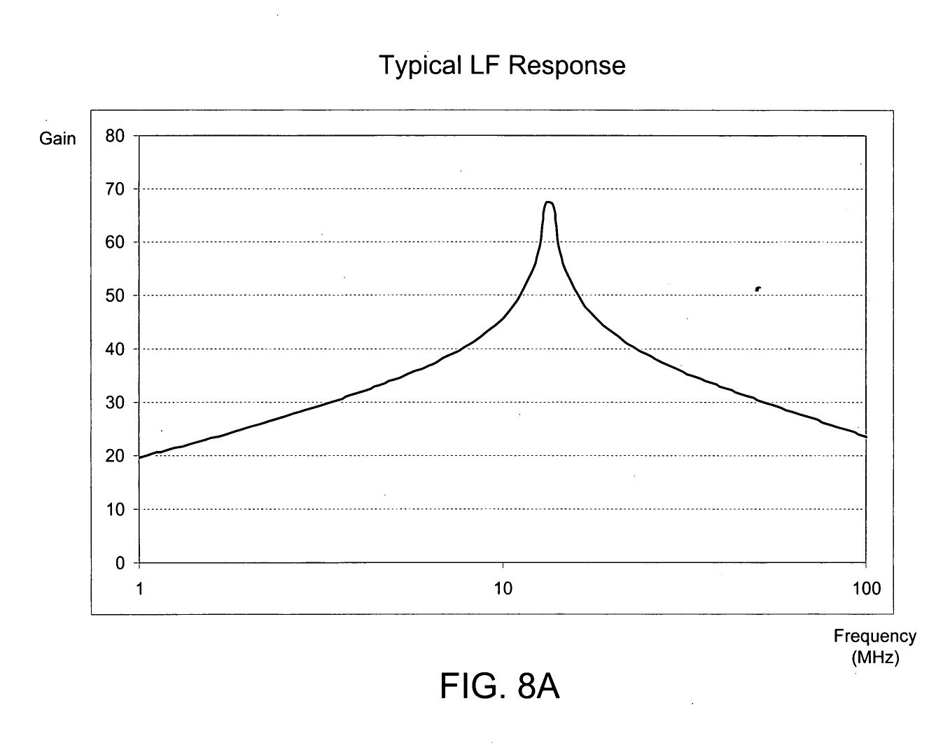

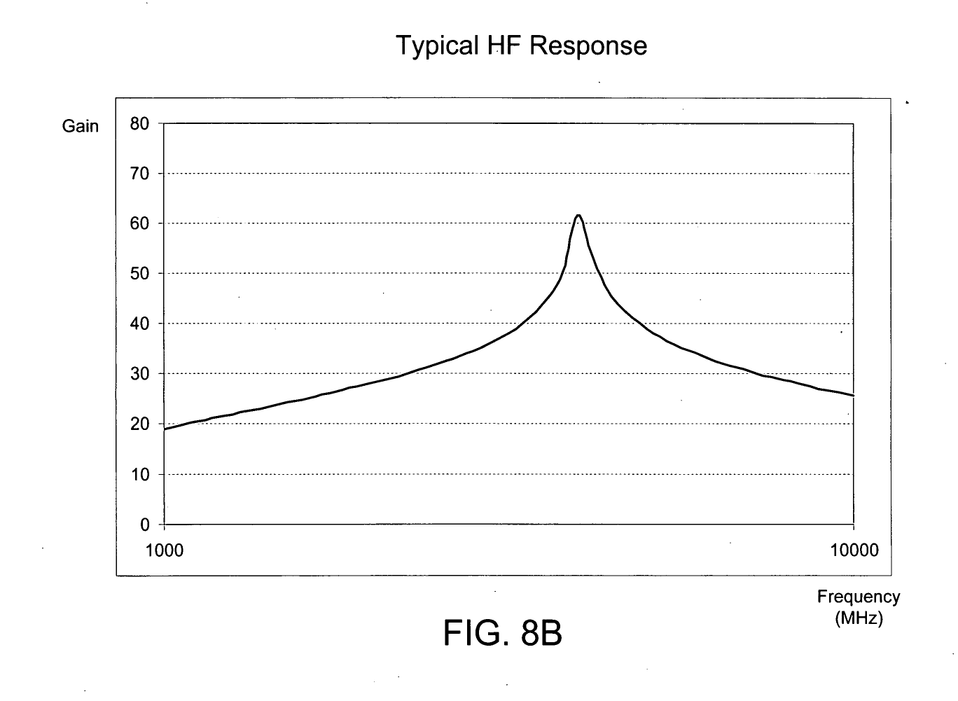

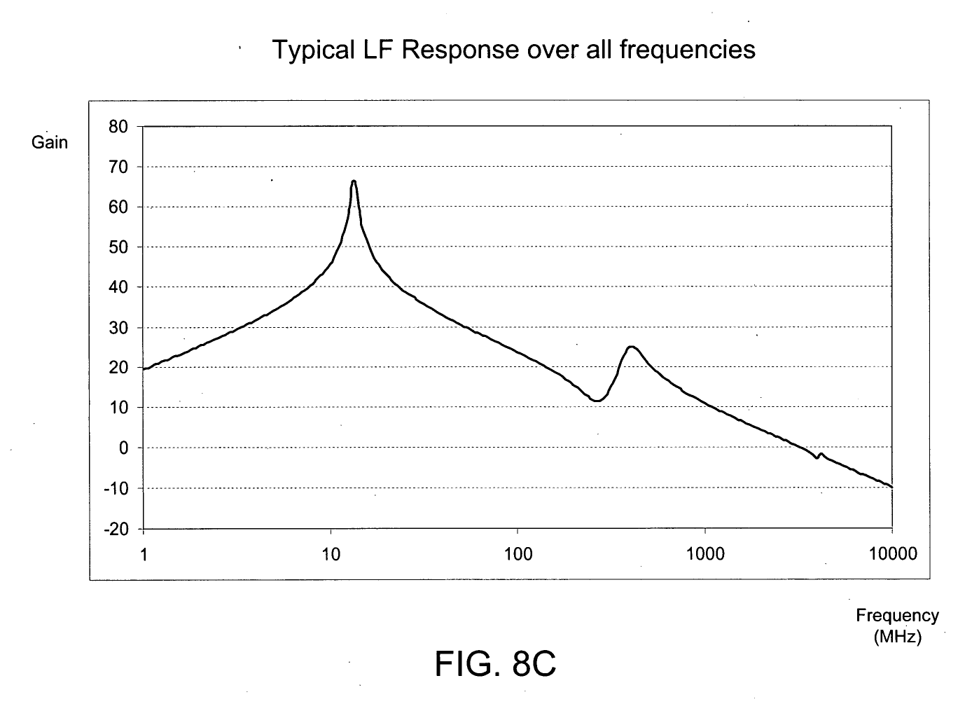

In the FIG. 6B embodiment, an effective low-frequency (LF) circuit is shown corresponding to the FIG. 6A equivalent circuit while functioning with low-frequency operation. As discussed above in conjunction with FIG. 5, at the low-frequency (LF), the impedances of Z2 and Z3 approach zero, and therefore the LF system essentially sees Z4 526 in parallel with Z1 514. Additional details regarding the implementation and operation of transceiver 222 are further discussed below in conjunction with FIGS. 7-8.

Referring now to FIGS. 7A and 7B, equivalent circuits to illustrate high-frequency operation of the FIG. 3 transceiver 222 are shown, in accordance with certain embodiments of the present invention. The FIG. 7 diagrams are presented for purposes of illustration, and in alternate embodiments, transceivers 228 may be implemented with components, circuits, functionalities, and characteristics in addition to, or instead of, certain of those components, circuits, functionalities, and characteristics discussed in conjunction with the FIG. 7 embodiment.

The FIG. 7A embodiment is a simplified circuit for transceiver 222. In the FIG. 7A embodiment, impedance Z1 514, impedance Z2 618, impedance Z3 522, and impedance Z4 526 are analogous to the identically named and numbered impedances from FIGS. 4, 5, and 6. Impedance Z1 514 includes, but is not limited to an inductance 614 and a capacitance 626. Impedance Z2 518 includes, but is not limited to, an inductance 618 and a capacitance 630. Impedance Z3 522 includes, but is not limited to, an inductance 622 and a capacitance 634. Impedance Z4 526 includes, but is not limited to, a capacitance 638. In the FIGS. 6A and 6B embodiments, a high-frequency (HF) transmit/receive signal 136 is shown.

In the FIG. 7B embodiment, an effective high-frequency (HF) circuit is shown corresponding to the FIG. 7A equivalent circuit while functioning with high-frequency operation. As discussed above in conjunction with FIG. 5, at the high-frequency (HF), the impedances of Z1 and Z4 approach zero, and therefore the GHz system will only see Z2 518 in parallel with Z3 522. Additional details regarding the implementation and operation of transceiver 222 are further discussed below in conjunction with FIG. 8.

Referring now to FIGS. 8A-8C, frequency response graphs for the FIG. 3 transceiver 222 are shown, in accordance with one embodiment of the present invention. The FIG. 8 graphs are presented for purposes of illustration. In alternate embodiments, transceiver 222 may utilize waveforms, frequency responses, timing relationships, and functionalities, in addition to, or instead of, certain of those waveforms, frequency responses, timing relationships, and functionalities discussed in conjunction with the FIG. 8 embodiment.

In the FIG. 8A embodiment, an exemplary low-frequency response for transceiver 222 is shown with frequency in megahertz on the horizontal axis and gain shown on the vertical axis. In low-frequency operation, a peak is shown at approximately 13 MHz. In the FIG. 8B embodiment, an exemplary high-frequency response for transceiver 222 is shown with frequency in megahertz on the horizontal axis and gain shown on the vertical axis. In high-frequency operation, a peak is shown at approximately 4 GHz. In the FIG. 8C embodiment, an exemplary frequency response for transceiver 222 is shown over all frequencies with frequency in megahertz on the horizontal axis and gain shown on the vertical axis. In concurrent low-frequency/high-frequency operation, a low-frequency peak is shown at approximately 13 MHz, and a high-frequency peak is shown at approximately 4 GHz. In accordance with the present invention, transceiver 222 therefore simultaneously and effectively provides improved dual-frequency operation by utilizing a single composite antenna 322.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A transceiver for performing wireless communication procedures, comprising:
a composite antenna that is configured to include both a low-frequency antenna and a high-frequency antenna; and
an integrated circuit that includes a low-frequency circuit and a high-frequency circuit, said low-frequency circuit supporting low-frequency communications over said low-frequency antenna, said high-frequency circuit supporting high-frequency communications over said high-frequency antenna.

2. The transceiver of claim 1 wherein said transceiver performs said low-frequency communications and said high-frequency communications at the same time.

3. The transceiver of claim 1 wherein said low-frequency antenna and said high-frequency antenna are implemented in a series configuration.

4. The transceiver of claim 1 wherein said composite antenna is coupled to said integrated circuit by utilizing two or fewer terminals.

5. The transceiver of claim 1 wherein said integrated circuit is coupled to said high-frequency antenna, said low-frequency antenna being coupled to said high-frequency antenna.

6. The transceiver of claim 1 wherein said low-frequency communications operate in a megahertz range, said high-frequency communications operating in a gigahertz range.

7. The transceiver of claim 1 wherein said transceiver is implemented in an electronic device for supporting said wireless communication procedures.

8. The transceiver of claim 1 wherein said electronic device is a smart card device that is implemented with a shape to enhance convenient portability.

9. The transceiver of claim 1 wherein said electronic device bi-directionally communicates with a host device through said transceiver.

10. The transceiver of claim 1 wherein said low-frequency communications include low-frequency transfers of commercial financial transaction data, said high-frequency communications including high-frequency transfers of image data.

11. The transceiver of claim 1 wherein said integrated circuit further comprises an impedance matching circuit to match impedances and provide isolation for said low-frequency circuit and said high-frequency circuit.

12. The transceiver of claim 11 wherein said low-frequency antenna has an impedance Z1, said high-frequency antenna having an impedance Z2, said impedance matching circuit having an impedance Z3, and said low-frequency circuit having an impedance Z4.

13. The transceiver of claim 1 wherein said impedance Z1 includes a Z1 inductance and a Z1 capacitance, said impedance Z2 includes a Z2 inductance and a Z2 capacitance, said Z3 impedance including a Z3 inductance and a Z3 capacitance, said Z4 impedance including a Z4 capacitance.

14. The transceiver of claim 12 wherein said low-frequency communications effectively see a high-frequency impedance of said high-frequency communications as zero, said low-frequency antenna and said low-frequency circuit thus simultaneously operating without any high-frequency suppression from said high-frequency communications.

15. The transceiver of claim 14 wherein said low-frequency communications effectively see said Z2 impedance and said Z3 impedance as zero, said low-frequency antenna and said low-frequency circuit thus simultaneously operating without any high-frequency suppression from said high-frequency communications.

16. The transceiver of claim 12 wherein said high-frequency communications effectively see a low-frequency impedance of said low-frequency communications as zero, said high-frequency antenna and said high-frequency circuit thus simultaneously operating without any low-frequency suppression from said low-frequency communications.

17. The transceiver of claim 16 wherein said high-frequency communications effectively see said Z1 impedance and said Z4 impedance as zero, said high-frequency antenna and said high-frequency circuit thus simultaneously operating without any low-frequency suppression from said low-frequency communications.

18. The transceiver of claim 7 wherein said electronic device further includes a central processing unit and a device memory with one or more device application programs.

19. The transceiver of claim 16 wherein said low-frequency communications operate in a 13 megahertz range, said high-frequency communications operating in a 4 gigahertz range.

20. A method for implementing a transceiver to perform wireless communication procedures, comprising the steps of:
configuring a composite antenna to include both a low-frequency antenna and a high-frequency antenna; and
providing an integrated circuit that includes a low-frequency circuit and a high-frequency circuit, said low-frequency circuit supporting low-frequency communications over said low-frequency antenna, said high-frequency circuit concurrently supporting high-frequency communications over said high-frequency antenna.
